(19) United States
(12) Patent Application Publication
(10) Pub. No.: US 2025/0095917 A1
(43) Pub. Date: Mar. 20, 2025

(54) INDUCTIVE COMPONENT AND METHOD FOR FABRICATING THE SAME

(71) Applicant: CHILISIN ELECTRONICS CORP., TAOYUAN CITY (TW)

(72) Inventors: CHUN-CHIH LIN, TAOYUAN CITY (TW); HSIN HSIEN YEH, TAOYUAN CITY (TW)

(21) Appl. No.: 18/885,815

(22) Filed: Sep. 16, 2024

(30) Foreign Application Priority Data
Sep. 18, 2023 (TW) 112135451

(51) Int. Cl. H01F 41/10; H01F 27/28; H01F 27/29; H01F 27/30; H01F 41/06

(52) U.S. Cl. CPC H01F 41/10; H01F 27/2828; H01F 27/292; H01F 27/306; H01F 41/06

(57) ABSTRACT

An inductive component and a method for fabricating the same are provided. The method includes: filling a mold with a first magnetic powder to form a base layer; forming a cavity in the base layer; inserting a coil corresponding to the cavity; filling the mold with a second magnetic powder to form a cover layer, in which the cover layer fills a space between the cavity and the corresponding coil and covers the base layer and the coil; executing a compression molding process to form a to-be-sliced package and taking the to-be-sliced package out; slicing the to-be-sliced package to obtain a to-be-packaged body; and forming a protective layer and an electrode part electrically connected to the coil on a surface of the to-be-packaged body.

### CROSS-REFERENCE TO RELATED PATENT APPLICATION

This application claims the benefit of priority to Taiwan Patent Application No. 112135451, filed on Sep. 18, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a component and a fabrication method thereof, and more particularly, to an inductive component and a method for fabricating the same.

### BACKGROUND OF THE DISCLOSURE

In the existing manufacturing process of small inductors, a single-part molding process supplemented by corresponding molding tools is often adopted, which easily leads to serious tool wear and tear during mass production, making it difficult to reduce the manufacturing costs. In addition, poor uniformity of the product thickness is caused by unequal heights during mold compression process with multiple molds.

Therefore, how to promote the product characteristics and reliability and further to reduce the mold cost and prolong the mold life through the improvements to the process and inductor structure has become one of the important issues that need to be solved in this field.

### SUMMARY OF THE DISCLOSURE

In view of the shortcomings in the prior art, the technical problem to be solved by the present disclosure is to provide an inductive component and a method for fabricating the same, which can promote the product characteristics and reliability and further reduce the mold cost and prolong the mold life.

To solve the foregoing technical problem, one of technical solutions adopted by the present disclosure is to provide a method for fabricating an inductive component, which includes: filling a mold with a first magnetic powder to form a base layer; forming at least one cavity in the base layer; placing at least one coil corresponding to the at least one cavity; filling the mold with a second magnetic powder to form a cover layer, where the cover layer fills a space between each cavity and the corresponding coil and covers the base layer and the at least one coil; executing a compression molding process to form a to-be-sliced package and taking the to-be-sliced package out of the mold; slicing the to-be-sliced package to obtain at least one to-be-packaged body; and forming a protective layer and an electrode part electrically connected to the coil on a surface of each to-be-packaged body.

To solve the foregoing technical problem, another technical solution adopted by the present disclosure is to provide an inductive component, which includes: a base layer, at least one coil, a cover layer, a protective layer, and an electrode part. The base layer includes a first magnetic powder and has at least one cavity. The at least one coil is correspondingly disposed in the at least one cavity. The cover layer includes a second magnetic powder, and fills a space between each cavity and the corresponding coil; and further covers the base layer and the at least one coil. The base layer, the at least one coil, and the cover layer together form an inductor body. The protective layer and the electrode part are disposed on the surface of the inductor body, where the electrode part is electrically connected to the at least one coil.

To further understand the features and technical content of the present disclosure, reference is made to the following detailed description and drawings related to the present disclosure. However, the provided drawings are merely used for reference and description, and are not intended to limit the present disclosure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an inductive component according to a first embodiment of the present disclosure;

FIG. 2 is a top view of an inductor in FIG. 1;

FIG. 3 is a section view along a line segment III-III in FIG. 2;

FIG. 4 is a section view of an inductive component according to a second embodiment of the present disclosure;

FIG. 5A is a top view of an inductive component according to a third embodiment of the present disclosure;

FIG. 5B is a section view along a line segment V-V in FIG. 5A;

FIG. 6 is a flowchart of a method for fabricating an inductive component according to a fourth embodiment of the present disclosure;

FIG. 7 is a schematic process diagram of steps S60 to S61;

FIG. 8 is a schematic process diagram of steps S61 to S62;

FIG. 9 is a schematic process diagram of steps S63 to S64;

FIGS. 10 and 11 are schematic process diagrams of steps S65 to S66; and

FIGS. 12 and 13 are schematic diagrams of a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The following describes an implementation manner of the present disclosure relating to an “inductive component and a method for fabricating the same” through specific embodiments. Those skilled in the art can easily understand the advantages and effects of the present disclosure from the content disclosed in the specification. The present disclosure can be embodied or applied through other different embodiments. Based on different opinions and applications, the details in the present specification can also be modified and changed without departing from the concept of the present disclosure. In addition, it should be stated first that the accompanying drawings of the present disclosure are merely for brief illustration and not drawn according to actual dimensions. The following embodiments will further explain the related technical content of the present disclosure, but the disclosed content is not intended to limit the protection scope of the present disclosure. In addition, the term “or” as used herein shall, according to the actual situation, include any one or a combination of more of the associated listed items.

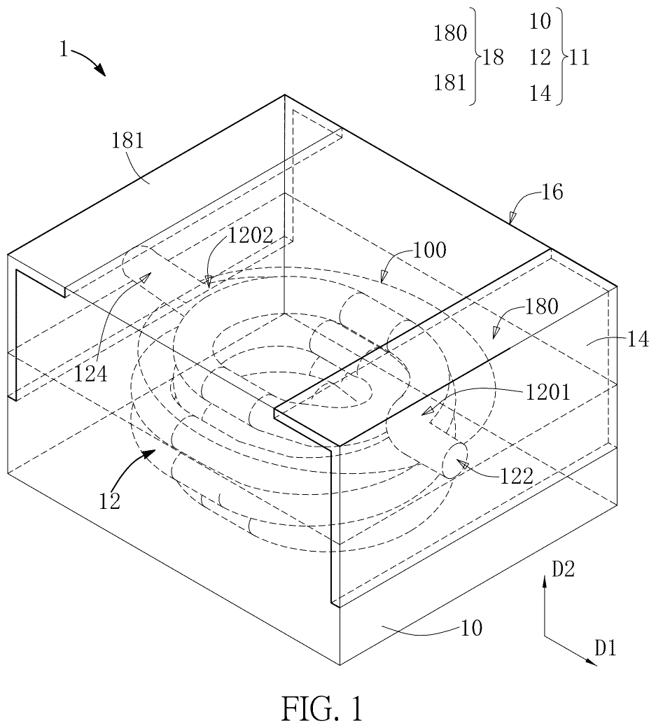

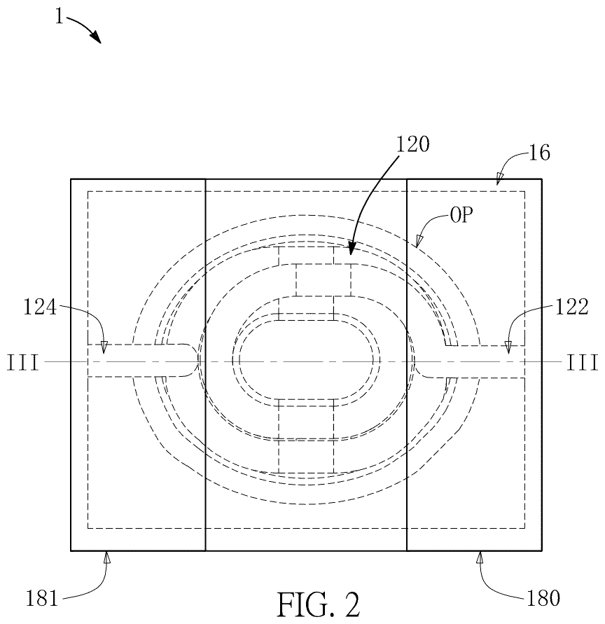

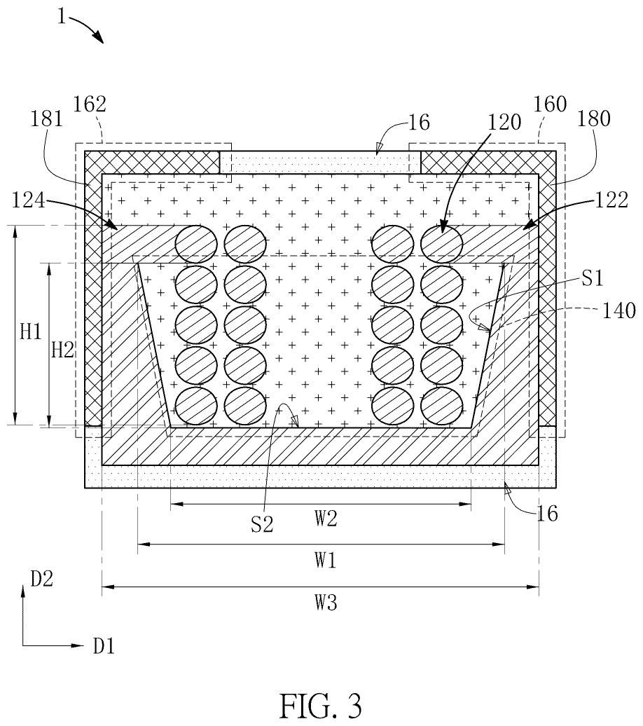

FIG. 1 is a schematic diagram of an inductive component according to a first embodiment of the present disclosure; FIG. 2 is a top view of an inductor in FIG. 1; and FIG. 3 is a section view along a line segment III-III in FIG. 2. Referring to FIGS. 1 to 3, the first embodiment of the present disclosure provides an inductive component 1, which includes a base layer 10, a coil 12, a cover layer 14, a protective layer 16, and an electrode part 18.

The base layer 10 may be formed into a cuboid as shown in FIGS. 1 to 3, which includes a first magnetic powder; and the base layer 10 is provided with a cavity 100 at its center. Viewed from the top view (FIG. 2), the cavity 100 may be formed by recessing from one of the surfaces of the base layer 10 and is a cylindrical cavity (e.g., a cylindrical cavity). The cavity 100 has an inner side surface S1 and a bottom surface S2, where the inner side surface S1 tilts at a predetermined angle with respect to the bottom surface S2. An opening OP is defined at an edge of the inner side surface S1 adjacent to an upper surface of the base layer 10, and its area is greater than the area of the bottom surface S2, so that at least a part (e.g., a coil body 120) of the coil 12 can pass through the opening. The top (e.g., the opening OP) of the cylindrical cavity has a first width W1 in a horizontal direction (e.g., a first direction D1), and the bottom (e.g., the bottom surface S2) of the cylindrical cavity has a second width W2 in a horizontal direction (e.g., the first direction D1), the first width W1 being greater than the second width W2.

The first magnetic powder may be a powder made by one of the following materials: iron, iron-nickel alloy, iron-cobalt alloy, iron-silicon alloy, iron-vanadium alloy, iron-silicon chromium alloy, iron-silicon aluminum alloy, iron-silicon aluminum alloy, iron-cobalt-vanadium alloy, iron-based amorphous alloy, iron-based nano-crystalline alloy, nickel-zinc ferrite, nickel-copper-zinc ferrite, and manganese-zinc ferrite. It should be noted that in order to mold the first magnetic powder, the base layer 10 may also include an adhesive, where the adhesive material may be an epoxy resin, a polysiloxane resin, an acrylic resin, a phenolic resin, or a polyvinyl alcohol. The weight percent concentration of the adhesive contained in the first magnetic powder may range from 0.5 wt % to 10 wt %, so as to ensure that the first magnetic powder has desired molding density and magnetic characteristics.

The coil 12 is disposed within the cavity 100. The coil 12 may be formed by winding a metallic wire made of a metallic conductor (e.g., copper), where the metallic wire may be, for example, a round wire, a flat wire (e.g., with a cross section having a length to width ratio not equal to 1), or a square wire, and may be wound in a flat (also known as horizontal winding) or outward (vertical or alpha) winding manner. Moreover, the present disclosure does not limit the wire form and the winding manner of the coil 12.

The coil 12 may include a coil body 120, a first pin portion 122 and a second pin portion 124, the first pin portion 122 being connected to a first end portion 1201 of the coil body 120 and the second pin portion 124 being connected to a second end portion 1202 of the coil body 120.

As shown in FIG. 1, the coil body 120 includes a plurality of loops overlapping each other, with the first end portion 1201 located at the uppermost loop of the coil body 120 and extending in a tangential direction along the loop. The first pin portion 122 is formed by bending the metallic wire toward a direction (e.g., the first direction D1) away from the center of the coil body 120 from the tangential direction with the first end portion 1201 as the starting point. Similarly, the second end portion 1202 is also located at the uppermost loop of the coil body 120 and extends along the tangential direction of the loop. The second pin portion 124 is formed by bending the metallic wire toward another direction (namely, a direction opposite to the first direction D1) away from the center of the coil body 120 from the tangential direction with the second end portion 1202 as the starting point. A first part of the coil body 120 is disposed in the cavity 100, and a second part of the coil body 120 is not disposed in the cavity 100, such that a part of the first pin portion and a part of the second pin portion may be disposed above the upper surface of the base layer 10.

One or more loops of the coil body 120 that are at the same height as the first end portion 1201 and the second end portion 1202 may not be disposed in the cavity 100, while the rest of the loops of the coil body 120 are disposed in the cavity 100, so that the corresponding first pin portion 122 and second pin portion 124 may extend directly to a position close to the surface of the inductive component 1, without being obstructed by the cavity 100.

However, in other embodiments, considering that the electrode part 18 may have other settings, the first pin portion 122 and the second pin portion 124 may be formed by bending the metallic wire toward the upper side of the coil body 120 (e.g., in a second direction D2) from the tangential direction, respectively with the first end portion 1201 and the second end portion 1202 as the starting points. That is to say, by adjusting the orientations of the first pin portion 122 and the second pin portion 124, the electrode part 18 can be drawn out from any side of the inductive component 1.

In addition, the coil body has a first height H1 and the cavity has a second height H2, the first height H1 being greater than the second height H2, and the heights of the first end portion 1201 and the second end portion 1202 both being greater than the second height H2, so that the first pin portion 122 and the second pin portion 124 are positioned above the corresponding cavity 100.

The dimensions of the coil body 120 may be determined by the dimensions of the outer diameter of the loop, which may be, for example, in the range of 0.5 mm to 5 mm, preferably in the range of 1.0 mm to 3.0 mm. The dimensions of the cavity 100 are slightly larger than that of the coil body 120. For the cylindrical cavity 100, its diameter may range from 0.6 to 5.1 mm, preferably from 1.01 mm to 3.01 mm. The coil body 120 and the cavity 100 having the above dimension range are also applicable to the inductive component 1 with specific product dimensions. For example, the cross-sectional length and width of the specific product dimensions may range from 1 mm*1 mm to 5 mm*5 mm.

Moreover, the cover layer 14 is formed above the base layer 10 and may be a cuboid similar to the base layer 10, and the base layer 14 has a shape that complements the base layer 10. In detail, since the base layer 10 has a cavity 100, the cover layer 14 may have a protrusion 140 corresponding to the cavity 100, which fills the gap between the cavity 100 and the coil 12, such that the cover layer 14 can cover both the base layer 10 and the coil 12.

The cover layer 14 may include a second magnetic powder and an adhesive, where the second magnetic powder may be a powder made of one of the following materials: iron, iron-nickel alloy, iron-cobalt alloy, iron-silicon alloy, iron-vanadium alloy, iron-silicon chromium alloy, iron-silicon aluminum alloy, iron-silicon aluminum alloy, iron-cobalt-vanadium alloy, iron-based amorphous alloy, iron-based nano-crystalline alloy, nickel-zinc ferrite, nickel-copper-zinc ferrite, and manganese-zinc ferrite. The adhesive material may be an epoxy resin, a polysiloxane resin, an acrylic resin, a phenolic resin, or a polyvinyl alcohol. The weight percent concentration of the adhesive contained in the second magnetic powder may range from 0.5 wt % to 10 wt %, so as to ensure that the second magnetic powder has desired molding density and magnetic characteristics. It should be noted that the first magnetic powder and the second magnetic powder use the same or different magnetic materials. For example, the characteristics of the inductive component 1 may be improved by using a combination of different magnetic materials for the upper (the cover layer 14) and lower (the base layer 10) parts.

In this embodiment, the base layer 10, the coil 12 and the cover layer 14 together form an inductor body 11 that has not yet been provided with the protective layer 16 and the electrode part 18. The inductor body 11 is presented as another cuboid formed by superposing the two cuboids of the base layer 10 and the cover layer 14, and the inductor body 11 may be integrally molded. In detail, the so-called integral molding means that when the base layer 10 and the cover layer 14 are made of the same or similar materials. That is, when the compositions of the first magnetic powder and the second magnetic powder are the same or similar, there is no obvious interface at the junction of the base layer 10 and the cover layer 14. Compared with the conventional assembly-type inductive components, the integrally molded inductive component 1 of the present disclosure can have higher durability and longer service life.

In addition, as shown in FIG. 3, the inductor body 11 has a third width W3 in the horizontal direction (the first direction D1), and the third width W3 is greater than the first width W1 and the second width W2. In addition, viewed from the section view (FIG. 3), the protective layer 16 and the electrode part 18 are disposed on the surface of the inductor body 11. The protective layer 16 has a first opening portion 160 and a second opening portion 162 that expose the surface of the inductor body 11, and the first opening portion 160 exposes a part of the first pin portion 122 and the second opening portion 162 exposes a part of the second pin portion 124. The first opening portion 160 and the second opening portion 162 are areas reserved for the electrode part 18 and may be, for example, in an L shape as shown in FIG. 3, but the present disclosure is not limited thereto. The protective layer 16 may be made of one of the following materials: epoxy resin, polysiloxane resin, acrylic resin, and phenolic resin.

In addition, the electrode part 18 includes a first electrode 180 and a second electrode 181 that are electrically connected to the coil 12, and more precisely, the first electrode 180 is electrically connected to the first pin portion 122 and the second electrode 181 is electrically connected to the second pin portion 124. The first electrode 180 and the second electrode 181 may fill the first opening portion 160 and the second opening portion 162 respectively, to form, together with the protective layer 16, an outer layer that completely covers all surfaces of the inductor body 11. The first electrode 180 and the second electrode 181 may be made of conductive metal, such as copper, nickel, tin, or conductive silver gel. The first electrode 180 and the second electrode 181 may, for example, have an L shape as shown in FIG. 3, but the setting manner is not limited thereto. The bending directions of the first pin portion 122 and the second pin portion 124 can be adjusted according to the design requirements, so that the first electrode 180 and the second electrode 181 can be drawn out from any side of all the surfaces of the inductor body 11 as external electrodes, thus enhancing the flexibility in applying the inductive component 1. In this case, the first electrode 180 and the second electrode 181 have a width same as the inductive body, but the present disclosure is not limited thereto.

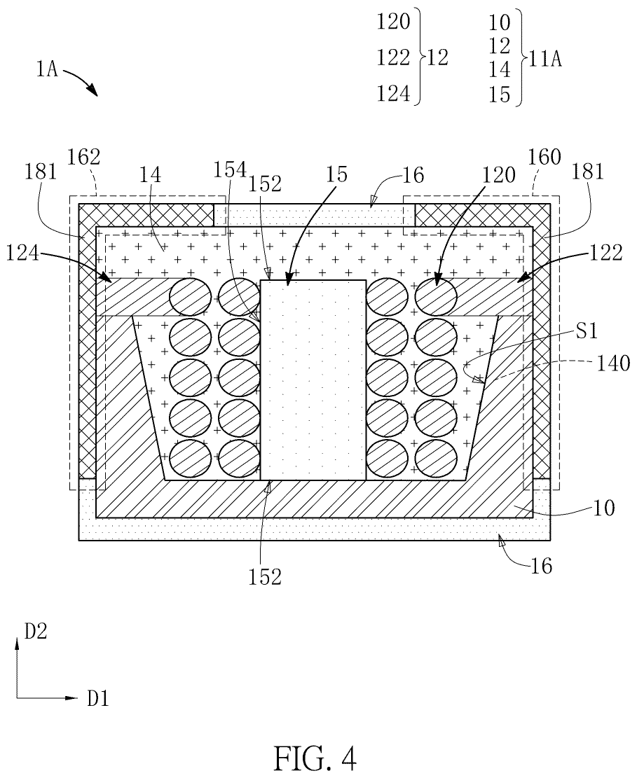

FIG. 4 is a section view of an inductive component according to a second embodiment of the present disclosure. As shown in FIG. 4, an inductive component 1A in the second embodiment of the present disclosure is similar to the inductive component 1 shown in FIGS. 1 to 3, and therefore the same elements are not described again. Different from the first embodiment, the inductive component 1A also includes a magnetic core 15, where the coil body 120 is formed around the magnetic core 15, and the base layer 10, the coil 12, the cover layer 14, and the magnetic core 15 together form an inductor body 11A that has not yet been provided with a protective layer 16 and an electrode part 18.

The magnetic core 15 may include a third magnetic powder and an adhesive, where the third magnetic powder may be a powder made of one of the following materials: iron, iron-nickel alloy, iron-cobalt alloy, iron-silicon alloy, iron-vanadium alloy, iron-silicon chromium alloy, iron-silicon aluminum alloy, iron-silicon aluminum alloy, iron-cobalt-vanadium alloy, iron-based amorphous alloy, iron-based nano-crystalline alloy, nickel-zinc ferrite, nickel-copper-zinc ferrite, and manganese-zinc ferrite. The adhesive material may be an epoxy resin, a polysiloxane resin, an acrylic resin, a phenolic resin, or a polyvinyl alcohol. The weight percent concentration of the adhesive contained in the third magnetic powder may range from 0.5 wt % to 10 wt %, so as to ensure that the third magnetic powder has desired molding density and magnetic characteristics. It should be noted that the first magnetic powder, the second magnetic powder, and the magnetic core use the same or two more different magnetic materials. Similarly, the characteristics of the inductive component 1 may be improved by using a combination of different magnetic materials for the cover layer 14, the base layer 10, and the magnetic core 15.

The magnetic core 15 may have a cylindrical structure, which may be, for example, a cylindrical structure or a square column structure, and the present disclosure is not limited thereto. The magnetic core 15 may have a first surface 150 and a second surface 152 that are opposite each other, and a side surface 154 between the first surface 150 and the second surface 152. The coil body 120 may be formed around the magnetic core 15. The height of the first surface 150 may be equal to or greater than the height of the highest point of the uppermost loop of the coil body 120, and the second surface 152 may be in contact with the bottom surface S2.

In some embodiment, the base layer 10, the cover layer 14, and the magnetic core 15 may be integrally formed. In detail, the so-called integral molding means that when the base layer 10, the cover layer 14, and the magnetic core 15 are made of the same or similar materials. That is, when the compositions of the first magnetic powder, the second magnetic powder, and the third magnetic powder are the same or similar, there is no obvious interface at the junction of any two of the base layer 10, the cover layer 14, and the magnetic core 15. Compared with the conventional assembly-type inductive components, the integrally molded inductive component 1 of the present disclosure can have higher durability and longer service life.

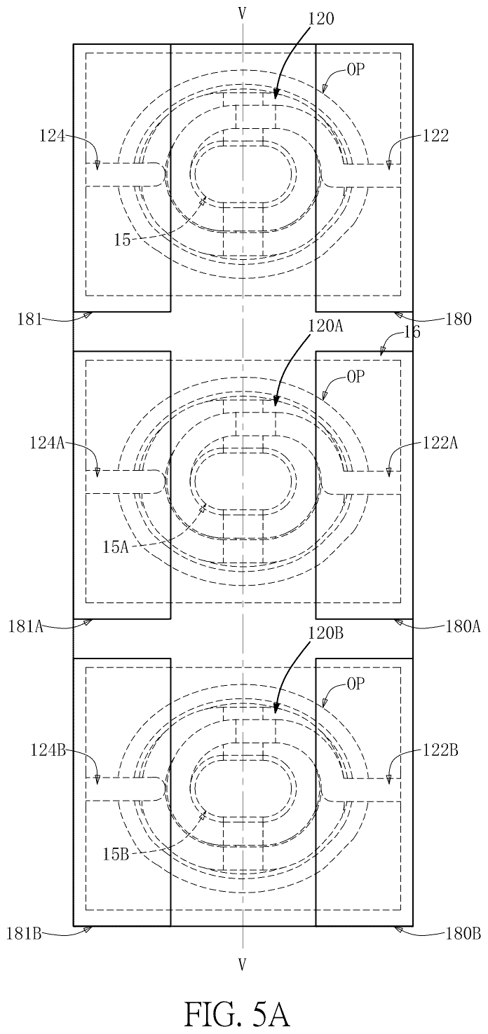

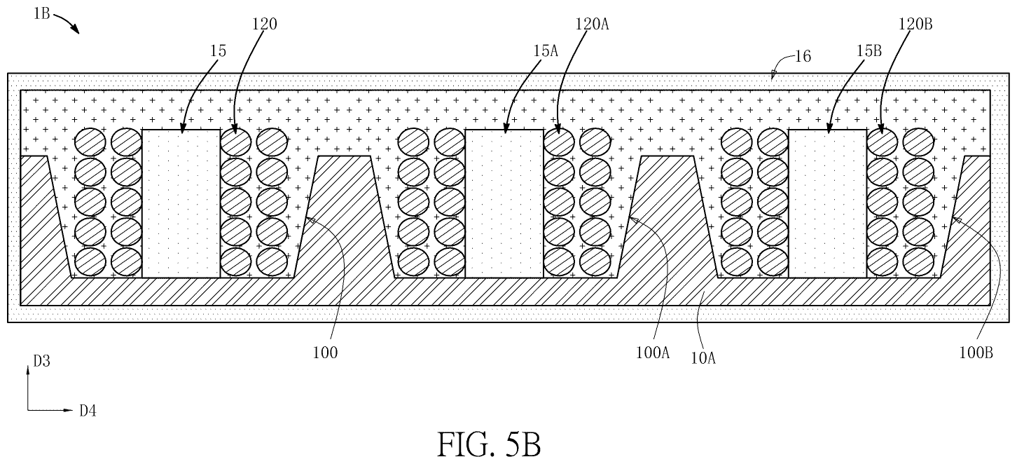

Referring to FIGS. 5A and 5B, FIG. 5A is a top view of an inductive component according to a third embodiment of the present disclosure, and FIG. 5B is a section view along a line segment V-V in FIG. 5A. As shown in FIGS. 5A and 5B, an inductive component 1B of the third embodiment of the present disclosure may be viewed as including a plurality (e.g., three) of inductor bodies 11A of FIG. 4. Specifically, a base layer 10A is provided with cavities 100, 100A, and 100B, where a coil body 120 is disposed corresponding to the cavity 100, a coil body 120A is disposed corresponding to the cavity 100A, and a coil body 120B is disposed corresponding to a cavity 100B. In addition, magnetic cores 15, 15A, 15B are disposed in the cavities 100, 100A, and 100B, respectively, where the coil body 120 is formed by winding around the magnetic core 15, the coil body 120A is formed by winding around the magnetic core 15A, and the coil body 120B is formed by winding around the magnetic core 15B.

In addition, because the inductive component 1B includes a plurality of inductor bodies 11A, the coil bodies 120, 120A and 120B may be electrically independent of each other. For example, the coil body 120 may be connected to the first electrode 180 and the second electrode 181 via the first pin portion 122 and the second pin portion 124, respectively. The coil body 120A may be connected to the first electrode 180A and the second electrode 181A via the first pin portion 122A and the second pin portion 124A, respectively. The coil body 120B may be connected to the first electrode 180B and the second electrode 181B via the first pin portion 122B and the second pin portion 124B, respectively. In addition, the first electrode 180 and the second electrode 181 are disposed in a direction parallel to the disposition direction of the first electrode 180A and the second electrode 181A, and the first electrode 180A and the second electrode 181A are disposed in a direction parallel to the disposition direction of the first electrode 180B and the second electrode 181B. However, the present disclosure is not limited to such connection and disposition manners.

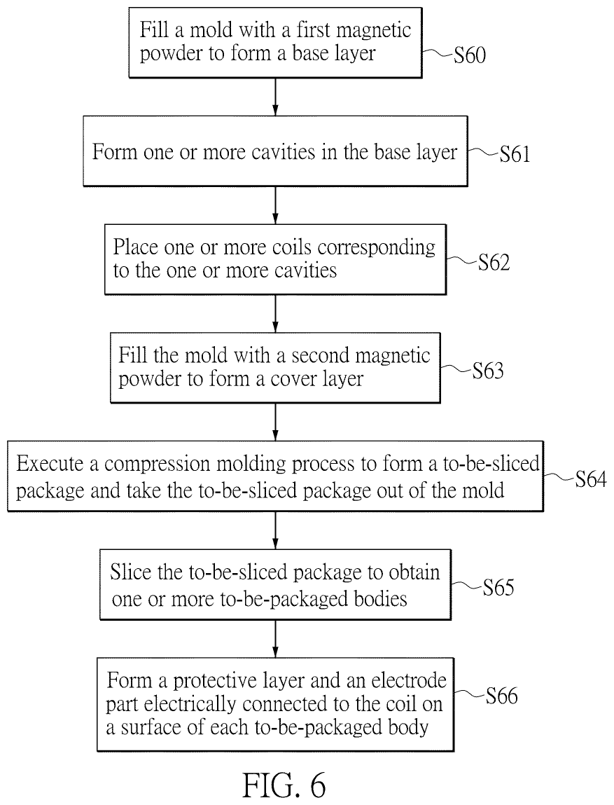

A fabrication method of the inductive component from FIGS. 1 to 5B is describe below, and FIG. 6 is a flowchart of a method for fabricating an inductive component according to a fourth embodiment of the present disclosure. The fourth embodiment of the present disclosure provides a method for fabricating an inductive component, where inductive components can be mass-produced by means of cavities in an array, and the mold structure is simple and the mold life can be greatly prolonged.

As shown in FIG. 6, the method for fabricating an inductive component includes the following steps:
Step S60: A mold is filled with a first magnetic powder to form a base layer.
Step S61: At least one cavity is formed in the base layer.
Step S62: At least one coil is disposed in at least one cavity.

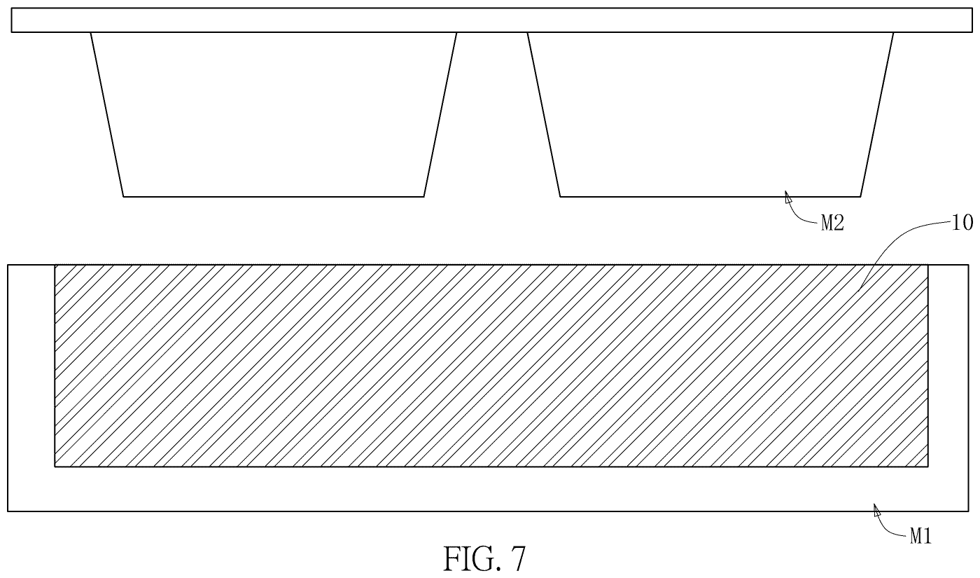

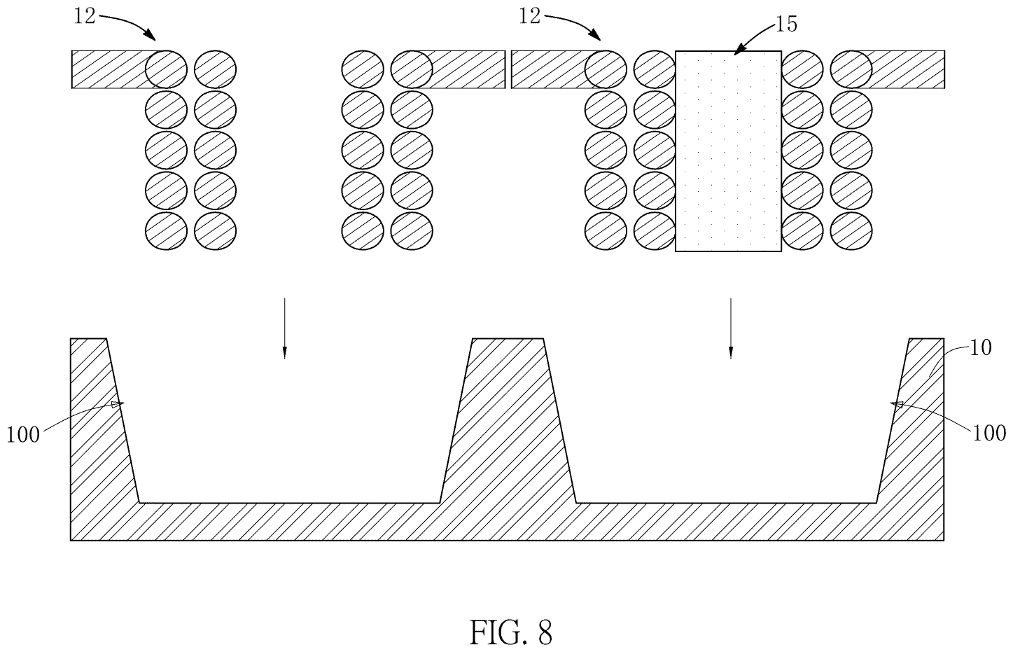

Referring to FIGS. 7 and 8, FIG. 7 is a schematic process diagram of steps S60 to S61; and FIG. 8 is a schematic process diagram of steps S61 to S62. As shown in the figures, after a mold M1 is filled with a first magnetic powder (and an adhesive) to form a base layer 10, a first compression molding process can be performed to press the first magnetic powder with the mold M2. It should be noted that the mold M2 is provided with protrusions of which the shapes are corresponding to the cavities 100 and 100A shown in FIGS. 1 to 5, and is used for pressing the base layer 10 to form corresponding cavities 100. The number of the cavities 100 is not limited to two shown in FIG. 8 and may be provided in the base layer 10 in an array from a top view.

After obtaining a plurality of cavities 100, a corresponding number of coils 12 may be obtained according to the number of the cavities 100, and the obtained coils 12 are placed in the cavities 100. It should be noted that the coils 12 may be formed in advance by winding. The coil 12 may be formed in advance by winding a metallic wire made of a metallic conductor (e.g., copper), which may be, for example, a round wire, a flat wire (e.g., with a cross section having a length to width ratio not equal to 1), or a square wire, and may be wound in a flat (also known as horizontal winding) or outward (vertical or alpha) winding manner. Moreover, the present disclosure does not limit the wire form and the winding manner of the coil 12.

In addition, if the inductive component to be fabricated is of the type shown in FIG. 4, the magnetic core 15 can be pre-molded with the third magnetic powder, and then the coil body 120 is wound around the magnetic core 15 to form the coil 12 (as shown on the right side of FIG. 8), and then the coil is implanted into the cavity 100 after winding completion.
Step S63: The mold is filled with a second magnetic powder, so as to form a cover layer.
Step S64: A compression molding process is performed to form a to-be-sliced package, and the to-be-sliced package is taken out of the mold.

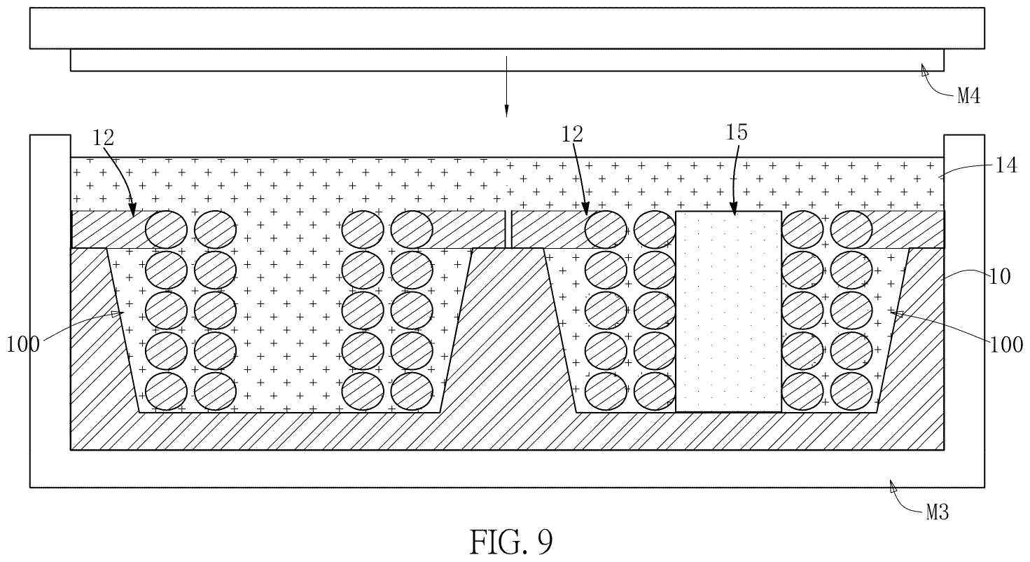

Refer to FIG. 9, which is a schematic process diagram of steps S63 to S64. As shown in FIG. 9, the base layer 10 disposed with the coils 12 and solidified under pressure can be placed in the mold M3 and then the mold is filled with the second magnetic powder. As a result, the formed cover layer 14 fills the gaps between the cavities 100 and the corresponding coils 12, and covers the base layer 10 and the coils 12 at the same time.

In the presence of the magnetic core 15, as shown on the right side of FIG. 9, the cover layer 14 formed by the second magnetic powder (and adhesive) fills the gaps between the cavities 100, the corresponding coils 12, and magnetic cores 15; and covers the base layer 10, the coils 12, and the magnetic core 15 at the same time.

Afterwards, a second press molding process can be performed to press the cover layer 14 with the mold M4 to mold a final cover layer 14. In this case, the to-be-sliced package is formed. It should be noted that in the procedure of the first and second press molding processes, the molds M1 to M4 can be heated in advance, so that part of the adhesive in the first magnetic powder and the second magnetic powder can escape to enhance the overall hardness of the finished product after pressing.
Step S65: The to-be-sliced package is sliced to obtain at least one to-be-packaged body.
Step S66: A protective layer and an electrode part electrically connected to the coil are formed on a surface of each to-be-packaged body.

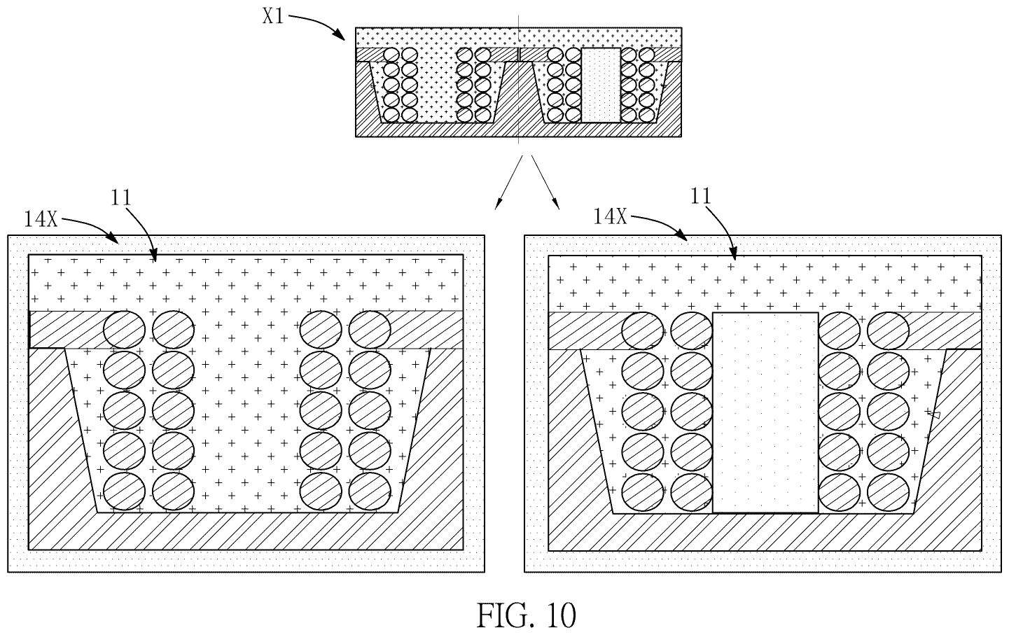

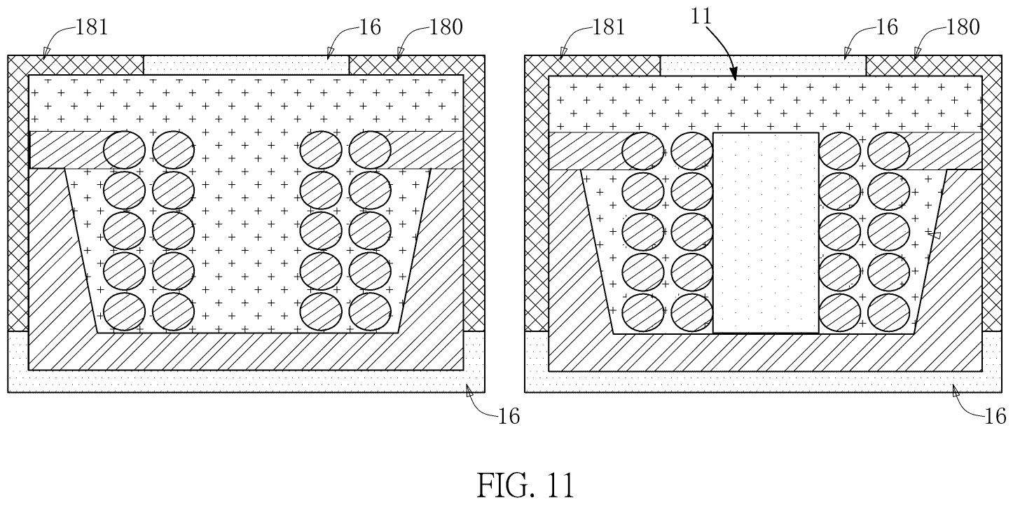

Please refer to FIGS. 10 and 11, which are schematic process diagrams of steps S65 to S66. As shown in FIG. 10, after the to-be-sliced package X1 is sliced into single or multiple inductor bodies 11, a spray coating process (or soaking of adhesive materials) is performed on the outer surface of the inductor body 11 to form a protective layer 16X to be treated that completely clad the inductor body 11. As described in previous embodiments, the inductor body 11 may be formed together by the base layer 10, the coil 12, and the cover layer 14; or together by the base layer 10, the coil 12, the magnetic core 15, and the cover layer 14, which is not described in detail herein again. In addition, during slicing, single inductive components 11 and 11A of FIGS. 1 to 4, or an inductive component 11B including multiple inductor bodies as in FIG. 5, may be formed as required.

Next, a part of the protective layer 18X to be treated may be removed. For example, the corresponding adhesive material is removed from an electrode area to be fabricated by a procedure such as laser, grinding, etc., to form the first opening portion 160 and the second opening portion 162 shown in FIG. 3, so as to expose a part of the first pin portion 122 and a part of the second pin portion 124 to form the protective layer 16. Afterwards, an electroplating process may be performed to form a first electrode 180 electrically connected to the first pin portion 122 and a second electrode 181 electrically connected to the second pin portion 124 at the first opening portion 160 and the second opening portion 162, respectively, by using the conductive metal, such as one of copper, nickel, and tin, as shown in FIGS. 1 to 5.

In this way, inductive components of the present disclosure can be mass-produced at the same time, with a simple mold structure, low manufacturing costs, high uniformity in thickness and quality of the inductive components produced in batches. Further, the characteristics of the inductive components can be improved by using a combination of different magnetic materials for the cover layer, the base layer (and the magnetic core).

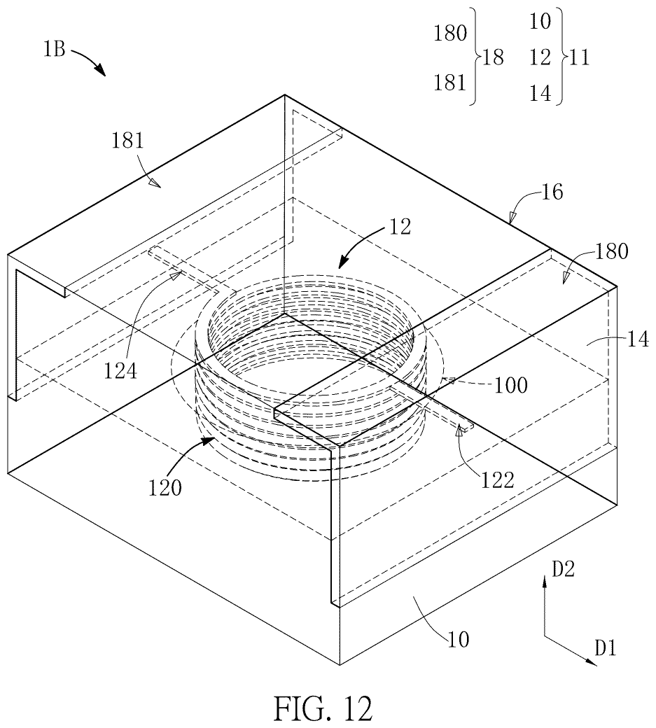

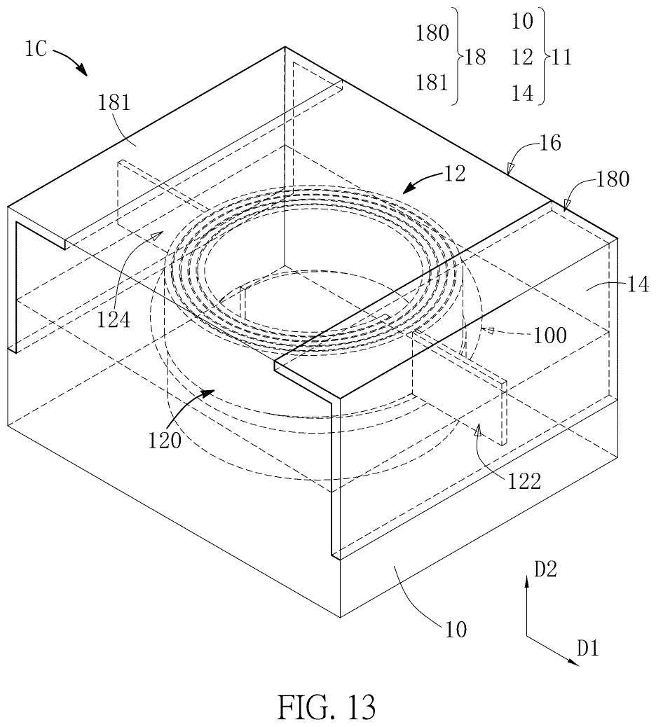

Furthermore, it should be noted that although the coils depicted in FIGS. 1 to 11 are round wires, the present disclosure is not limited thereto. Refer to FIGS. 12 and 13, which are schematic diagrams of an inductive component in a fifth embodiment of the present disclosure. In the fifth embodiment, element symbols similar to FIG. 1 refer to similar elements and are not described in detail again. For example, as shown in FIG. 12, in an inductive component 1B, the coil is formed by winding a flat wire having a rectangular cross-section. Specifically, the flat wire is wound and stacked in a plurality of loops of the same diameter so that the height of the coil body 120 is higher than or equal to the depth of the cavity 100, and then the flat wire is bent to extend towards the two sides of the coil body 120 to form the first pin portion 122 and the second pin portion 124, thus finally forming the coil 12. It should be noted that the contact faces of the loops are the long edges of the flat wire.

On the other hand, as shown in FIG. 13, in an inductive component 1C, the flat wire is first wound from the inside to the outside to form a winding bodies, and then the winding bodies are stacked so that the height of the coil body 120 is higher than or equal to the depth of the cavity 100. Afterwards, the flat wire is bent to extend towards the two sides of the coil body 120 to form the first pin portion 122 and the second pin portion 124, thus finally forming the coil 12. It should be noted that in each layer of the winding body, the contact faces of the flat wires are the long sides of the flat wire, while the contact surfaces between different layers of the winding bodies are the short sides of the flat wire.

### Beneficial Effects of the Embodiments

One of the advantageous effects of the present disclosure is that, by using a winding-type solid-state electrolytic capacitor packaging structure and its fabrication method provided by the present disclosure, the present disclosure can form hundreds or thousands of inductive components by means of one-time mold compression, thus greatly improving the thickness and quality uniformity of the product, and further improving the characteristics of the inductive component by using a combination of different magnetic materials for the cover layer, the base layer (and the magnetic core).

The content disclosed above only describes preferred and feasible embodiments of the present disclosure, and is not intended to limit the scope of patent application of the present disclosure. Therefore, all equivalent technical changes made by using the description and the content of the present disclosure are all included in the scope of the patent application of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for fabricating an inductive component, comprising the following processes:
filling a mold with a first magnetic powder to form a base layer;
forming at least one cavity in the base layer;
placing at least one coil corresponding to the at least one cavity;
filling the mold with a second magnetic powder to form a cover layer, wherein the cover layer fills a space between each cavity and the corresponding coil and covers the base layer and the at least one coil;
executing a compression molding process to form a to-be-sliced package and taking the to-be-sliced package out of the mold;
slicing the to-be-sliced package to obtain at least one to-be-packaged body; and
forming a protective layer and an electrode part electrically connected to the coil on a surface of each to-be-packaged body.

2. The fabrication method of claim 1, further comprising:
preparing the at least one coil, wherein each coil comprises:
a coil body;
a first pin portion, connected to a first end portion of the coil body; and
a second pin portion, connected to a second end portion of the coil body.

3. The fabrication method of claim 2, wherein the coil body has a first height and each cavity has a second height, the first height being greater than the second height, and the heights of the first end portion and the second end portion both being greater than the second height, so that the first pin portion and the second pin portion are positioned above the corresponding cavity.

4. The fabrication method of claim 3, wherein the process of preparing the at least one coil further comprises: winding each coil body around a magnetic core to form the coil.

5. The fabrication method of claim 2, wherein the process of forming a protective layer and an electrode part electrically connected to the coil on a surface of each to-be-packaged body comprises:
performing a spray coating process on the surface of each to-be-packaged body, so as to form a to-be-treated protective layer;
removing a part of the to-be-treated protective layer to expose a part of the first pin portion and a part of the second pin portion, to form the protective layer; and
forming a first electrode electrically connected to the first pin portion and a second electrode electrically connected to the second pin portion on the surface of each to-be-packaged body.

6. The fabrication method of claim 1, wherein the first magnetic powder and the second magnetic powder use same or different magnetic materials.

7. The fabrication method of claim 4, wherein the first magnetic powder, the second magnetic powder, and the magnetic core use same or two or more different magnetic materials.

8. The fabrication method of claim 2, wherein the cavity is a cylindrical cavity, the top of the cylindrical cavity has a first width in a horizontal direction, and the bottom of the cylindrical cavity has a second width in the horizontal direction, each to-be-packaged body has a third width in the horizontal direction, the first width being greater than the second width, and the third width being greater than the first and second width.

9. The fabrication method of claim 8, wherein a first part of each coil body is disposed in the corresponding cavity, a second part of the coil body is not disposed in the corresponding cavity, and a part of the first pin portion and a part of the second pin portion are located above the upper surface of the base layer surrounding the cavity.

10. The fabrication method of claim 9, wherein each cavity has a bottom surface and an inner side surface surrounding the bottom surface, and a distance between each coil and the inner side surface of the corresponding cavity in the horizontal direction is in within a range from 0 mm to 0.5 mm.

11. An inductive component, comprising:
a base layer comprising a first magnetic powder and having at least one cavity;
at least one coil correspondingly disposed in the at least one cavity;
a cover layer comprising a second magnetic powder, wherein the cover layer fills a space between each cavity and the corresponding coil, and further covers the base layer and the at least one coil, and wherein the base layer, the at least one coil, and the cover layer together form an inductor body;
a protective layer and an electrode part, disposed on the surface of the inductor body, wherein the electrode part is electrically connected to the at least one coil.

12. The inductive component of claim 11, wherein each coil comprises:
a coil body;
a first pin portion connected to a first end portion of the coil body; and
a second pin portion connected to a second end portion of the coil body.

13. The inductive component of claim 12, wherein the coil body has a first height and the cavity has a second height, the first height being greater than the second height, and the heights of the first end portion and the second end portion both being greater than the second height, so that the first pin portion and the second pin portion are positioned above the corresponding cavity.

14. The inductive component of claim 13, further comprising a magnetic core, wherein the coil body is formed by winding around the magnetic core.

15. The inductive component of claim 12, wherein a part of the first pin portion and a part of the second pin portion are exposed from the protective layer, and the electrode part comprises a first electrode electrically connected to the first pin portion and a second electrode electrically connected to the second pin portion.

16. The inductive component of claim 11, wherein the first magnetic powder and the second magnetic powder use same or different magnetic materials.

17. The inductive component of claim 14, wherein the first magnetic powder, the second magnetic powder, and the magnetic core use same or two or more different magnetic materials.

18. The inductive component of claim 12, wherein the cavity is a cylindrical cavity, the top of the cylindrical cavity has a first width in a horizontal direction, the bottom of the cylindrical cavity has a second width in the horizontal direction, and each inductor body has a third width in the horizontal direction, the first width being greater than the second width, and the third width being greater than the first and second width.

19. The inductive component of claim 18, wherein a first part of each coil body is disposed in the corresponding cavity, a second part of the coil body is not disposed in the corresponding cavity, and a part of the first pin portion and a part of the second pin portion of each coil are located above the upper surface of the corresponding cavity defined by the base layer.

20. The inductive component of claim 19, wherein each cavity has a bottom surface and an inner side surface surrounding the bottom surface, and a distance between each coil and the inner side surface of the corresponding cavity in the horizontal direction is in within a range from 0 mm to 0.5 mm.
